(19) United States
(12) Patent Application Publication
(10) Pub. No.: US 2006/0139522 A1
(43) Pub. Date: Jun. 29, 2006

(54) Transflective liquid crystal display device with balanced chromaticity

(75) Inventors: Wei-Chih Chang, Jubei City (TW); Li-Sen Chuang, Penghu Hsien (TW); Dai-Liang Ting, Hsinchu City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/023,219

(22) Filed: Dec. 27, 2004

(51) Int. Cl. G02F 1/1335

(52) U.S. Cl. 349/114; 349/106

(57) ABSTRACT

A four color transflective liquid crystal display device is disclosed. Each main pixel area includes three primary color sub-pixel areas and a white sub-pixel area. Each primary color sub-pixel area includes a first transmissive portion and a first reflective portion. The white sub-pixel area includes a second reflective portion and a second transmissive portion. The second reflection reflects a substantively white light to raise display brightness in the reflective mode. Thus, the chromaticity of the reflective mode approaches that of the transmissive mode.

### BACKGROUND OF THE INVENTION

1. Field of the Invention

The present invention relates to a transflective liquid crystal display device, and more particularly, to a transflective liquid crystal display device with balanced chromaticity in both transmissive and reflective modes.

2. Description of the Related Art Liquid crystal display (LCD) devices are widely used as displays in electronic devices such as portable computers, PDAs and cell phones. Liquid crystal display devices are classified into two types. One is transmissive type, and the other is reflective type. The former utilizes a backlight as the light source and the latter utilizes ambient light. It is difficult to decrease the power consumption for the transmissive LCD due to the power requirements of the backlight. As for the reflective LCD, it has the advantage of lower power consumption under bright ambient light, but is hindered by environments with less ambient light.

In order to overcome the drawbacks of these two types of LCDs, a transflective LCD is disclosed. Transflective LCDs are capable of displaying images in both transmissive and reflective modes. Under bright ambient light, the backlight can be turned off, so the power consumption of the transflective LCD is lower than that of the transmissive LCD. Additionally, when less ambient light is available, the backlight can be turned on, so the image quality of the transflective LCD is better than that of the reflective LCD.

FIG. 1 is an exploded perspective view illustrating a typical transflective LCD device. The transflective LCD device includes an upper substrate 10 and a lower substrate 20 with a liquid crystal layer 50 interposed therebetween. The upper substrate 10 is a color filter substrate and the lower substrate 20 is an array substrate. In the upper substrate 10, on a surface opposing the lower substrate 20, a black matrix 12 and a color filter layer 14 including a plurality of red (R), green (G) and blue (B) color filters are formed. That is, the black matrix 12 surrounds each color filter, in the shape of an array matrix. Further on the upper substrate 10, a common electrode 16 is formed to cover the color filter layer 14 and the black matrix 12.

In the lower substrate 20, on a surface opposing the upper substrate 10, a TFT “T” serving as a switching device is formed in shape of an array matrix corresponding to the color filter layer 14. In addition, a plurality of crossing gate and data lines 26 and 28 are positioned such that each TFT is located near each cross point of the gate and data lines 26 and 28. Further on the lower substrate 20, a plurality of pixel regions (P) are defined by the gate and data lines 26 and 28. Each pixel region P has a pixel electrode 22 comprising a transparent portion 22a and an opaque portion 22b. The transparent portion 22a comprises a transparent conductive material, such as ITO (indium tin oxide) or IZO (indium zinc oxide), and the opaque portion 22b comprises a metal having high reflectivity, such as Al (aluminum).

FIG. 2 is a sectional view of a conventional transflective LCD device, which helps to illustrate the operation of such device. As shown in FIG. 2, the conventional transflective LCD device includes a lower substrate 200, an upper substrate 260 and a liquid crystal layer 230 interposed therebetween. The upper substrate 260 has a common electrode 240 and a color filter 250 formed thereon. The color filter 250 includes red (R), green (G) and blue (B) regions. The lower substrate 200 has an insulating layer 210 and a pixel electrode 220 formed thereon, wherein the pixel electrode 220 has an opaque portion 222 and a transparent portion 224. The opaque portion 222 of the pixel electrode 220 can be an aluminum layer, and the transparent portion 224 of the pixel electrode 220 can be an ITO (indium tin oxide) layer. The opaque portion 222 reflects ambient light 270, while the transparent portion 224 transmits light 280 from a backlight device 290 disposed at the exterior side of the lower substrate 200. The liquid crystal layer 230 is interposed between the lower and upper substrates 200 and 260. Therefore, the transflective LCD device is capable of display in both reflective and transmissive modes.

Referring to FIG. 2, the backlight 280 penetrates the transmissive portion 224 and passes through the color filter 250 once, and the ambient light 270 is reflected by the reflective portion 222 and passes through the color filter 250 twice. This leads to different chromaticity in the reflective and transmissive regions, decreasing display quality.

U.S. Pat. No. 5,233,385 discloses a method for increasing the brightness of a scene in a color projection. This method uses a white light to raise the brightness in both temporal and spatial filtering systems.

U.S. Pat. No. 5,929,843 discloses a method and apparatus for processing image data comprising the steps of extracting white component data from input R, G, B data, suppressing the white component data in accordance with a non-linear characteristic, generating R, G, B, W display data and driving a liquid crystal display panel having R, G, B, W filters in accordance with R, G, B, W data in order to display a full color image.

U.S. Publication No. 2004/0046725 discloses a four color liquid crystal display including R,-G., B and W pixels, for improving optical efficiency.

None of the above cited references are directed to transflective LCD displays.

### SUMMARY OF THE INVENTION

The present invention is directed to a novel transflective LCD structure configured to reduce the difference in chromaticity between the transmissive mode and the reflective mode by providing a substantively white light in the reflective mode. In one aspect of the present invention, a novel structure is disclosed wherein the pixel area comprises a white sub-pixel area providing a white light in the reflective mode, compared to the transmissive mode. In another aspect of the present invention, a method for normalizing chromaticity between transmissive and reflective modes of a transflective LCD device is disclosed. The structure and method of the present invention comprises the provision of a white sub-pixel area that supports a white light to raise brightness in the reflective mode, compared to the transmissive mode.

In one embodiment, a transflective LCD device having a plurality of main pixel areas is provided, wherein each main pixel area comprises three primary sub-pixels and a white sub-pixel. Each sub-pixel comprises a transmissive portion and a reflective portion and corresponds to a color filter. The color filter comprises three primary color regions and a white region, wherein the primary sub-pixels correspond to the primary color regions and the white sub-pixel corresponds to the white region. The white region may have no color layer or have a transparent resist layer. When the transflective LCD device is operated in a transmissive mode, the white sub-pixel is driven to not emit light. Conversely, when the transflective LCD device is operated in a reflective mode, the white sub-pixel area is driven to emit light. That is, the white sub-pixel only provides the white light in the reflective mode, thereby normalizing chromaticity between transmissive and reflective modes.

In another embodiment, a transflective LCD device comprising a plurality of main pixel areas is provided, wherein each main pixel area comprises three primary sub-pixels and a white sub-pixel and a color filter corresponding to the sub-pixels. Each primary sub-pixel comprises a transmissive portion and a reflective portion and the white sub-pixel is a reflective pixel. The color filter comprises three primary color regions and a white region, wherein the primary sub-pixels correspond to the primary color regions and the white sub-pixel corresponds to the white region. The white region may have no color layer or have a transparent resist layer. When the transflective LCD device is operated in a transmissive mode, there is no light transmitted through the white sub-pixel. Conversely, when the transflective LCD device is operated in a reflective mode, the white sub-pixel reflects ambient light to display white light, thereby normalizing chromaticity between transmissive and reflective modes.

The present invention improves the chromaticity of the conventional transflective LCD devices by introducing a white sub-pixel to provide white light in the reflective mode. The white sub-pixel comprises a reflective portion reflecting the white light when in the reflective mode. Thus, the chromaticity of the reflective mode approaches that of transmissive mode, improving display quality.

### BRIEF DESCRIPTION OF THE DRAWINGS

The invention can be more fully understood by reading the subsequent detailed description in conjunction with the examples and references made to the accompanying drawings, wherein:

FIG. 1 is an exploded perspective view illustrating a typical transflective LCD device;

FIG. 2 is a sectional view illustrating the operation of a conventional transflective LCD. device;

FIG. 3 illustrates a part of a transflective LCD device according to the present invention, showing a main pixel area consisting of three primary color sub-pixel areas and a white sub-pixel area;

FIG. 4A is a sectional view of a transflective LCD device according to a first embodiment of the present invention, illustrating the operation thereof in a transmissive mode;

FIG. 4B is a sectional view of a transflective LCD device according to a first embodiment of the present invention, illustrating the operation thereof in a reflective mode;

FIG. 5A is a sectional view of a transflective LCD device according to a second embodiment of the present invention, illustrating the operation thereof in a transmissive mode;

FIG. 5B is a sectional view of a transflective LCD device according to a second embodiment of the present invention, illustrating the operation thereof in a reflective mode; and

FIG. 6 is a schematic diagram of an electronic device incorporating a transflective LCD device of the present invention.

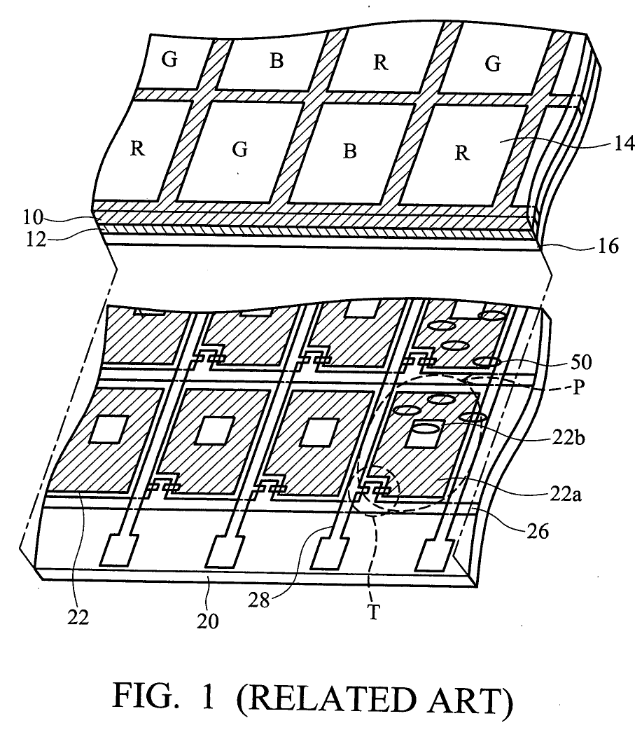

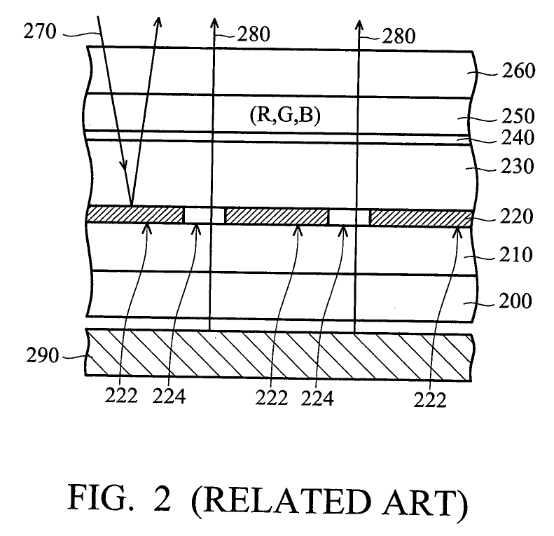

### DETAILED DESCRIPTION OF THE INVENTION

Reference will now be made in detail to preferred embodiments of the present invention, examples of which are illustrated in the accompanying drawings. Wherever possible, the same reference numbers are used in the drawings and the description to refer to the same or like parts.

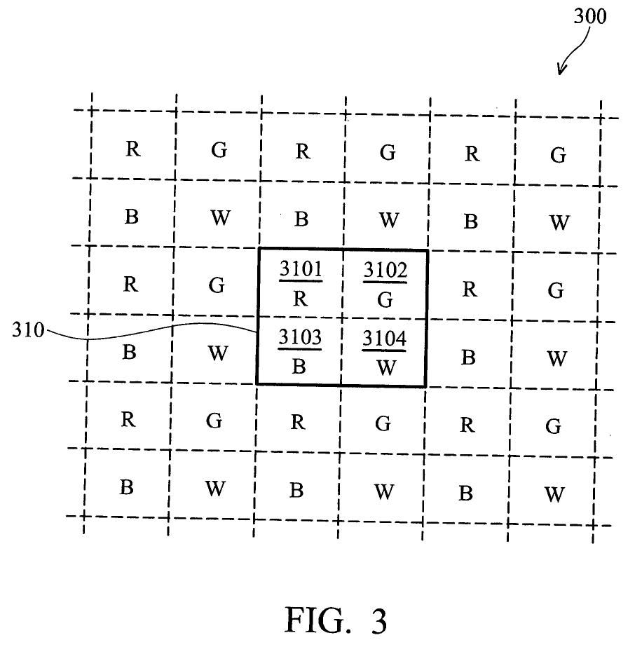

FIG. 3 illustrates a portion of a transflective LCD device 300 according to one embodiment of the present invention. The transflective LCD device 300 comprises a plurality of main pixel areas 310, wherein each main pixel area 310 consists of at least one color sub-pixel area (three primary color sub-pixel areas 3101, 3102 and 3103 are represented hereinafter) and a white sub-pixel area 3104. In FIG. 3, numeral“3101” represents a red (R) sub-pixel area, numeral “3102” represents a green (G) sub-pixel area and numeral “3103” represents a blue (B) sub-pixel area. The arrangement of the sub-pixel areas 3101, 3102, 3103 and 3104 is a chessboard type shown in FIG. 3, but is not intended to limit the present invention. That is, the arrangement of the sub-pixel areas 3101, 3102, 3103 and 3104 can be a stripe type, a mosaic type, a delta type or others.

### FIRST EMBODIMENT

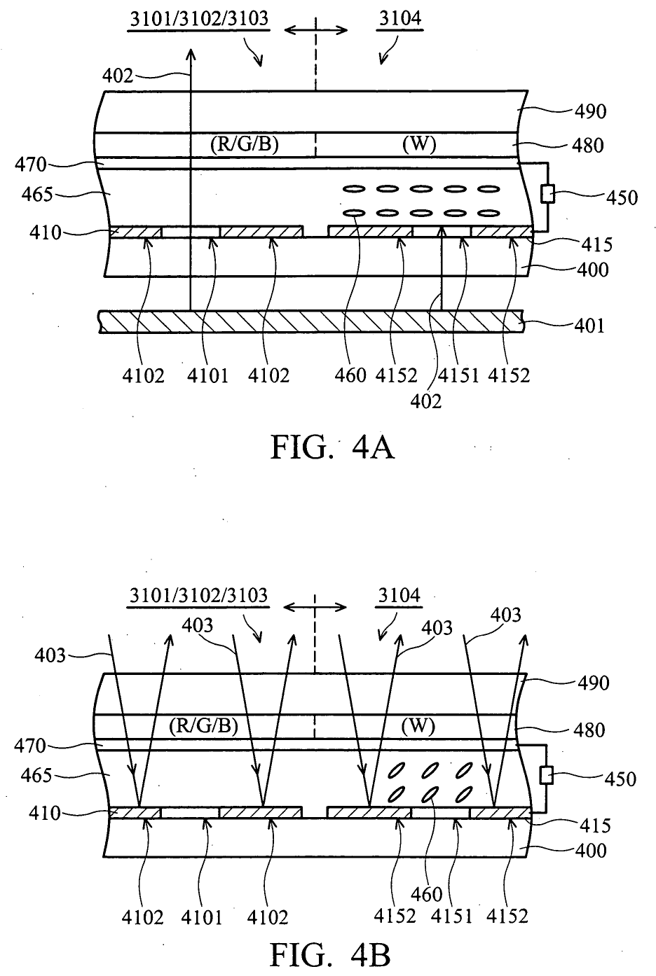

FIG. 4A is a sectional view schematically showing one main pixel area 310 of the transflective LCD device 300 according to the first embodiment of the present invention and illustrating the operation thereof in a transmissive mode. FIG. 4B illustrates the operation of the transflective LCD device 300 according to the first embodiment in a reflective mode. The main pixel area 310 comprises red, green and blue sub-pixel areas 3101, 3102 and 3103 and a white sub-pixel area 3104. For simplicity, the three primary color sub-pixel areas 3101, 3102, and 3103 and a white sub-pixel area 3104 are respectively shown in FIGS. 4A and 4B.

A first substrate 400, serving as a lower substrate, can be a glass substrate including an array of pixel driving elements (not shown), such as an array of thin film transistors (TFTs). A backlight device 401 is disposed at the outer side (i.e. the backside) of the first substrate 400. Three primary sub-pixel electrodes 410 and an additional sub-pixel electrode 415 are formed on the first substrate 400, wherein each primary sub-pixel electrode 410 is located in each primary color sub-pixel area 3101/3102/3103 and the additional sub-pixel electrode 415 is located in the white sub-pixel area 3104. Note that a representative primary sub-pixel electrode 410 is shown in FIGS. 4A and 4B. Each primary sub-pixel electrode 410 comprises a first transmissive portion 4101 and a first reflective portion 4102. The additional sub-pixel electrode 415 comprises a second transmissive portion 4151 and a second reflective portion 4152. The first and second transmissive portions 4101 and 4151 can be transparent conductive material such as ITO (indium tin oxide) or IZO (indium zinc oxide). The first and second reflective portions 4102 and 4152 can be opaque and reflective material such as aluminum, aluminum alloy or silver.

A second substrate 490, such as glass, opposite the first substrate 400 is provided. The second substrate 490 serves as an upper substrate. A color filter 480 is formed on the inner side of the second substrate 490. The color filter 480 comprises three primary color regions R, G and B and a white region W. The white region W may have no color layer or have a transparent resist layer. Note that a representative primary color region R/G/B is shown in FIGS. 4A and 4B. Each primary sub-pixel electrode 410 corresponds to each primary color region R/G/B. The additional sub-pixel electrode 415 corresponds to the white region W.

A common electrode 470 is then formed on an inner side of the second substrate 490. The common electrode 470 may be an ITO or IZO layer. In FIGS. 4A and 4B, liquid crystal molecules 460 fill a space between the first substrate 400 and the second substrate 490 to form a liquid crystal layer 465. The liquid crystal orientation of the liquid crystal layer 465 is controlled by an electric field generating electrodes such as sub-pixel electrodes 410 and 415 and the common electrode 470. In this embodiment, the additional sub-pixel electrode 415 and the common electrode 470 are electrically connected to a controller 450 further. The controller 450 is used to adjust the electric field intensity between the additional sub-pixel electrode 415 and the common electrode 470, thereby controlling the liquid crystal orientation above the additional sub-pixel electrode 415.

An operational example of this embodiment is illustrated hereinafter.

FIG. 4A illustrates the operation of the transflective LCD device 300 according to the first embodiment of the present invention in a transmissive mode. In FIG. 4A, a backlight 402 from the backlight device 401 passes through the primary color regions R, G and B once. According to this embodiment, the liquid crystal orientation above the additional sub-pixel electrode 415 is controlled to emit different brightness light levels by the controller 450. In one aspect of this embodiment, the controller 450 controls the white sub-pixel area 3104 not to emit light (i.e. the white sub-pixel area 3104 is dark), thus the color gamut is preserved in the transmissive mode. And in another aspect of this embodiment, the white sub-pixel area 3104 is allowed to emit light, so the color gamut will change with the difference brightness light.

FIG. 4B illustrates the operation of the transflective LCD device 300 according to the first embodiment of the present invention in a reflective mode. A reflective light 403 from an exterior light source (not shown) passes through the primary color regions R, G and B twice, causing display color in the reflective mode to be darker than that in the transmissive mode. At this time, according to the present invention, the liquid crystal orientation above the additional sub-pixel electrode 415 is controlled by the controller 450 to cause the reflective light 403 to penetrate the liquid crystal layer 465 above the second reflective portion 4152 (i.e. the additional sub-pixel electrode 415). That is, the controller 450 controls the white sub-pixel area 3104 to emit white light to raise display brightness and dilute the color purity in the reflective mode, thereby reducing color gamut of the reflective mode to approach that of the transmissive mode. Also, the white sub-pixel area 3104 can be driven to not to emit white light, thus the color gamut of the reflective mode is greater than that of the transmissive mode. It is noted that the controller 450 can adjust power output to modulate the brightness of the white light emitted from the white sub-pixel area 3104 to a desired level. Thus, the overall chromaticity for the two modes may be controlled to a desired point, which may be substantially the same chromaticity or different chromaticity.

### SECOND EMBODIMENT

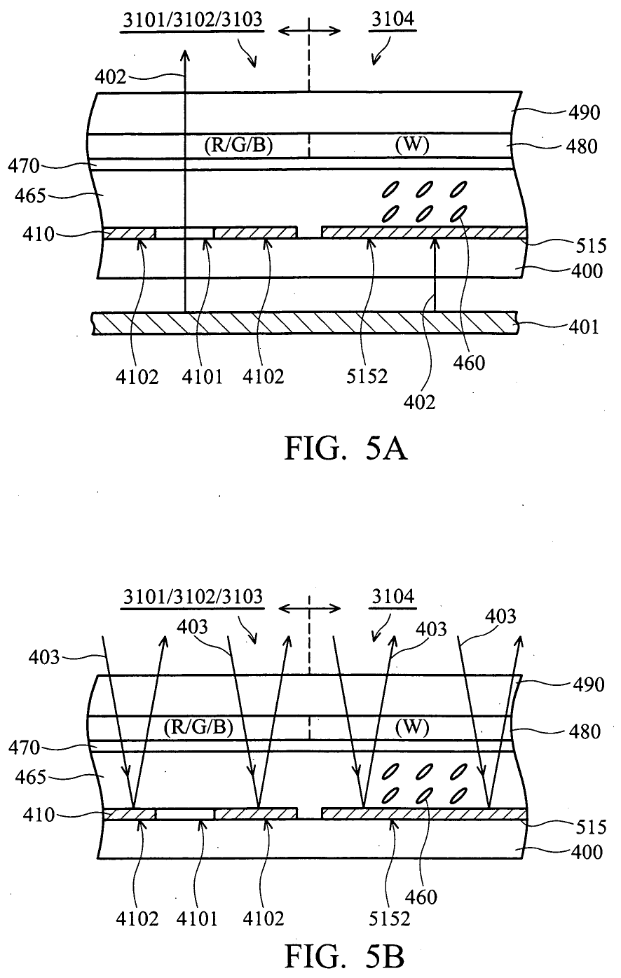

FIG. 5A is a sectional view schematically showing one main pixel area 310 of the transflective LCD device 300 according to the second embodiment of the present invention and illustrating the operation thereof in a transmissive mode. FIG. 5B illustrates the operation of the transflective LCD device 300 according to the second embodiment in a reflective mode. Elements in FIGS. 5A and 5B repeated from FIGS. 4A and 4B use the same reference numbers.

The main pixel area 310 comprises red, green and blue sub-pixel areas 3101, 3102 and 3103 and a white sub-pixel area 3104. For simplicity, the three primary color sub-pixel areas 3101, 3102, and 3103 and a white sub-pixel area 3104 are respectively shown in FIGS. 5A and 5B.

A first substrate 400, serving as a lower substrate, can be a glass substrate including an array of pixel driving elements (not shown), such as an array of thin film transistors (TFTs). A backlight device 401 is disposed at the outer side (i.e. the backside) of the first substrate 400. Three primary sub-pixel electrodes 410 and an additional sub-pixel electrode 515 are formed on the first substrate 400, wherein each primary sub-pixel electrode 410 is located in each primary color sub-pixel area 3101/3102/3103 and the additional sub-pixel electrode 515 is located in the white sub-pixel area 3104. Note that a representative primary sub-pixel electrode 410 is shown in FIGS. 5A and 5B. Each primary sub-pixel electrode 410 comprises a first transmissive portion 4101 and a first reflective portion 4102. The additional sub-pixel electrode 515 merely comprises a reflective portion 5152. The first transmissive portion 4101 can be transparent conductive material such as ITO (indium tin oxide) or IZO (indium zinc oxide). The reflective portion 5152 can be opaque and reflective material such as aluminum, aluminum alloy or silver. That is, the additional sub-pixel electrode 515 is a reflective layer.

A second substrate 490, such as a glass substrate, disposed opposite the first substrate 400 is provided. The second substrate 490 serves as an upper substrate. A color filter 480 is formed on the inner side of the second substrate 490. The color filter 480 comprises three primary color regions R, G and B and a white region W. The white region W may have no color layer or have a transparent resist layer. Note that a representative primary color region R/G/B is shown in FIGS. 5A and 5B. Each primary sub-pixel electrode 410 corresponds to each primary color region R/G/B. The additional sub-pixel electrode 515 corresponds to the white region W.

A common electrode 470 is then formed on an inner side of the second substrate 490. The common electrode 470 may be an ITO or IZO layer. In FIGS. 5A and 5B, liquid crystal molecules 460 fill a space between the first substrate 400 and the second substrate 490 to form a liquid crystal layer 465. The liquid crystal orientation of the liquid crystal layer 465 is controlled by an electric field generating electrodes such as sub-pixel electrodes 410 and 515 and the common electrode 470.

An operational example of this embodiment is illustrated hereinafter.

FIG. 5A illustrates the operation of the transflective LCD device 300 according to the second embodiment of the present invention in a transmissive mode. A backlight 402 from the backlight device 401 passes through the primary color regions R, G and B once. Note that the additional sub-pixel electrode 515 blocks backlight 402 from the backlight device 401 because the additional sub-pixel electrode 515 is opaque. That is, the white sub-pixel area 3104 does not emit light (i.e. the white sub-pixel area 3104 is dark) in the transmissive mode.

FIG. 5B illustrates the operation of the transflective LCD device 300 according to the second embodiment of the present invention in a reflective mode. A reflective light 403 from an exterior light source (not shown) passes through the primary color regions R, G and B twice, causing display color in the reflective mode to be darker than that in the transmissive mode. At this time, according to the invention, the white sub-pixel area 3104 emits a white light to raise display brightness by reflection of the additional sub-pixel electrode 515, thereby causing the chromaticity of the reflective mode to approach that of the transmissive mode.

Although the color filter 480 is located on the inner side of the second substrate 490 in the first and second embodiments, the color filter 480 can overlie the first substrate 400 by known COA (color filter on array) technology. For example, the color filter 480 can be formed on the sub-pixel electrodes 410 and 415/515. The conventional COA processes and structures are described in, for example, U.S. Pat. No. 6,162,654. In order to avoid obscuring aspects of the present invention, detailed COA processes and structures are not described again here. Depending on designs, the sub-pixel electrodes 410, 415, 515 can be supported by the second substrate 490 and the common electrode 470 can be supported by the first substrate 400.

The present invention provides a novel transflective LCD device and a method for normalizing chromaticity between transmissive and reflective modes of a transflective LCD device. The present invention employs the white sub-pixel area providing a white light in the reflective mode. The white sub-pixel area comprises a reflective portion reflecting the white light during the reflective mode. Thus, the chromaticity of the reflective mode approaches that of the transmissive mode, improving display quality.

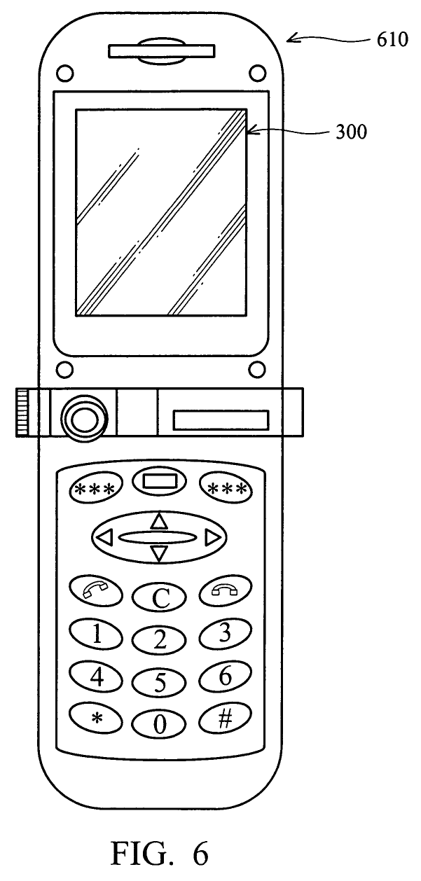

FIG. 6 is a schematic diagram of an electronic device 610 incorporating a transflective LCD 300 of the present invention. The electronic device 610 can be a mobile phone, a hand-held computer and others. A representative mobile phone is shown in FIG. 6. Even so, the teachings may be further applied to any form of display device comprising the transflective LCD 300. The electronic device 610 comprises the transflective LCD 300 of the present invention, control electronics (such as ICs and others, not shown) operatively coupled to the transparent LCD 300 and other components (such as a keypad). The control electronics are used to control the transparent LCD 300 to display an image in accordance with display data.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A transflective liquid crystal display device comprising a plurality of main pixel areas, each main pixel area comprising:
at least one primary color sub-pixel area, wherein the at least one primary color sub-pixel area comprises a first transmissive portion and a first reflective portion; and
a white sub-pixel area, wherein the white sub-pixel area comprises a second reflective portion.

2. The transflective LCD device according to claim 1, wherein the white sub-pixel area further comprises a second transmissive portion.

3. The transflective LCD device according to claim 1, wherein each main pixel areas comprise three color sub-pixel areas which correspond to primary colors.

4. The transflective LCD device according to claim 3, wherein the primary colors include red, green and blue.

5. The transflective LCD device according to claim 1, wherein the at least one color sub-pixel area is defined by an electrode comprising a transmissive portion and a reflective portion, and at least one color region of a color filter corresponding to the at least one color sub-pixel area.

6. The transflective LCD device according to claim 5, wherein the white sub-pixel area is defined by a white region of the color filter.

7. The transflective LCD device according to claim 6, wherein the white region of the color filter is transparent to white light.

8. The transflective LCD device according to claim 7, wherein the white sub-pixel area is further defined by an electrode comprising a reflective portion.

9. The transflective LCD device according to claim 8, wherein the white sub-pixel area is further defined by the electrode comprising a transmissive portion.

10. The transflective LCD device according to claim 1, further comprising a first substrate and a second substrate disposed opposite each other with a liquid crystal layer interposed therebetween, wherein the at least one color sub-pixel area is defined by a color region of a color filter supported by one of the first and second substrates, a first electrode comprising a transmissive portion and a first reflective portion supported by at least one of the first and second substrates, and the white sub-pixel area is defined by a second electrode comprising a second reflective portion supported by at least one of the first and second substrates and a white region of the color filter supported by at least one of the first and second substrates.

11. The transflective LCD device according to claim 10, wherein the white region of the color filter comprises a transparent material.

12. A transflective liquid crystal display device comprising a plurality of main pixel areas, each main pixel area comprising:
three primary sub-pixel electrodes and an additional sub-pixel electrode disposed on a substrate, wherein each primary sub-pixel electrode comprises a first transmissive portion and a first reflective portion and the additional sub-pixel electrode comprises a second reflective portion; and
a color filter comprising three primary color regions and a white region, wherein the primary sub-pixel electrodes correspond to the primary color regions and the additional sub-pixel electrode corresponds to the white region.

13. The transflective LCD device according to claim 12, wherein the substrate is a glass substrate comprising an array of thin film transistors.

14. The transflective LCD device according to claim 12, wherein the additional sub-pixel electrode further comprises a second transmissive portion.

15. The transflective LCD device according to claim 14, further comprising a controller electrically connected to the additional sub-pixel electrode, wherein the controller controls a brightness level of a white light emitted from the white sub-pixel area.

16. The transflective LCD device according to claim 15, wherein the first and second transmissive portions are transparent conductive layers and the first and second reflective portions are reflective layers.

17. The transflective LCD device according to claim 12, wherein the three primary color regions comprise red, green and blue color regions.

18. A transflective liquid crystal display device comprising a plurality of main pixel areas, each main pixel area comprising:
a first substrate and a second substrate disposed opposite each other with a liquid crystal layer interposed therebetween;
three primary sub-pixel electrodes and an additional sub-pixel electrode formed on the first substrate, wherein each primary sub-pixel electrode comprises a first transmissive portion and a first reflective portion and the additional sub-pixel electrode comprises a second reflective portion;
a color filter formed on an inner side of the second substrate, wherein the color filter comprises three primary color regions and a white region, the primary sub-pixel electrodes correspond to the primary color regions and the additional sub-pixel electrode corresponds to the white region; and
a common electrode formed over the color filter.

19. The transflective LCD device according to claim 18, wherein the additional sub-pixel electrode further comprises a second transmissive portion.

20. An electronic device, comprising:
a transflective liquid crystal display device as in claim 1; and
control electronics operatively coupled to the transflective liquid crystal display device, controlling the transflective liquid crystal display device to display an image in accordance with display data.
